(19) United States
(12) Patent Application Publication
(10) Pub. No.: US 2004/0109926 A1
(43) Pub. Date: Jun. 10, 2004

(54) Method of decreasing acrylamide in food cooked under heat

(75) Inventors: Yoshio Tomoda, Tokyo (JP); Akihiro Hanaoka, Chiba-shi (JP); Toshitaka Yasuda, Kawasaki-shi (JP); Tomo Takayama, Tokyo (JP); Ado Hiwatashi, Kawasaki- (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: TOYO SUISAN KAISHA, LTD., Tokyo (JP)

(21) Appl. No.: 10/725,990

(22) Filed: Dec. 1, 2003

(30) Foreign Application Priority Data
Dec. 3, 2002 (JP) 2002-351292
Jun. 10, 2003 (JP) 2003-165507
Nov. 10, 2003 (JP) 2003-379978

(51) Int. Cl. A23C 3/00

(52) U.S. Cl. 426/523

(57) ABSTRACT

A method of preparing food to be cooked under heat or food cooked under heat, which is capable of decreasing acrylamide contained in the food after the cooking, wherein the method comprises adding to the food at least one compound selected from the group consisting of (a1) neutral amino acids and salts thereof, (a2) basic amino acids and salts thereof, (a3) neutral imino acids and salts thereof, (b) sulfonic acids and salts thereof and/or at least one peptide complex of peptides having, as constituting components thereof, any one of the amino acids of the items (a1) to (a3).

### CROSS-REFERENCE TO RELATED APPLICATIONS

This application is based upon and claims the benefit of priority from the prior Japanese Patent Applications No. 2002-351292, filed Dec. 3, 2002; No. 2003-165507, filed Jun. 10, 2003; and No. 2003-379978, filed Nov. 10, 2003, the entire contents of all of which are incorporated herein by reference.

### BACKGROUND OF THE INVENTION

1. Field of the Invention

The present invention relates to methods of preparing food to be cooked under heat and food cooked under heat, capable of decreasing acrylamide. The present invention also relates to food to be cooked under heat and food cooked under heat with lowered acrylamide prepared by using such methods.

2. Description of the Related Art

Food can be modified by cooking under heat so as to facilitate the decomposition and absorption of proteins and carbohydrates contained in the food. There are various methods of cooking food by heating, such as boiling, steaming, baking, and frying, and the cooking method is selected appropriately in accordance with, for example, the components of the food and the taste.

In recent years, traces of components which were not detected in the past, included in the components contained in various substances, have come to be detected due to the progress of analysis equipment. For example, a Swedish researcher reports that traces of acrylamide are formed by the cooking under heat of a livestock feed, as disclosed in, for example, “Chemical Research in Toxicology 13”: pp. 517-522 (2000). Also, a British researcher reports that asparagine, which is the main amino acid of potato and cereals, is mainly involved in the formation of acrylamide, as reported in, for example, “Nature” 419, pp. 448-450 (2002).

### BRIEF SUMMARY OF THE INVENTION

The present inventors also considered that, since noodles, which are handled in their business, use cereals as the raw materials and are cooked under heat during the preparation process thereof, it may be possible for acrylamide to be formed in the noodles and have begun to conduct research into acrylamide formation.

The present inventors have surprisingly found that it is possible to prepare instant fried noodles having lowered acrylamide by adding a compound selected from the group consisting of specific amino acids, sulfonic acids and salts thereof, or a specific peptide complex containing such an amino acid to the noodles before the cooking under heat. It has also been found that it is possible to decrease acrylamide in cooked foods under heat at high temperatures, e.g., fried with oil or baked in an oven, such as potato chips and cookies, by adding the compound selected from the group consisting of specific amino acids, sulfonic acids and salts thereof or the peptide complex containing such an amino acid to the raw materials before the cooking under heat.

That is, an object of the present invention is to provide a method of preparing food to be cooked under heat or food cooked under heat capable of decreasing acrylamide. The object was achieved by the flowing means.

(1) A method of preparing food to be cooked under heat or food cooked under heat, which is capable of decreasing acrylamide contained in the food after the cooking, wherein the method comprises adding to the food at least one compound selected from the group consisting of (a1) neutral amino acids and salts thereof, (a2) basic amino acids and salts thereof, (a3) neutral imino acids and salts thereof, (b) sulfonic acids and salts thereof and/or at least one peptide complex of peptides having, as constituting components thereof, any one of the amino acids of the items (a1) to (a3).

(2) The method of preparing food to be cooked under heat or food cooked under heat according to item (1), wherein the neutral amino acid and the salt thereof belonging to item (a1) are selected from nonpolar neutral amino acids consisting of glycine, alanine and salts thereof, and polar neutral amino acids consisting of serine, cysteine and salts thereof; the basic amino acid and the salt thereof belonging to item (a2) are selected from the group consisting of lysine, arginine, histidine and salts thereof; the neutral imino acid and the salt thereof belonging to item (a3) are selected from the group consisting of proline, hydroxyproline and salts thereof; and the sulfonic acid and salt thereof belonging to item (b) is taurine.

(3) The method of preparing food to be cooked under heat or food cooked under heat according to item (1) or (2), wherein the salt includes an amino acid salt selected from the group consisting of L-arginineL-glutamate and L-lysineL-glutamate, and the peptide complex is selected from the group consisting of glutathione and polylysine.

(4) The method of preparing food to be cooked under heat or food cooked under heat according to any one of items (1) to (3), wherein the food contains a cereal flour and/or starch.

(5) The method of preparing food to be cooked under heat or food cooked under heat according to any one of items (1) to (4), wherein the temperature at which the food is to be cooked or cooked under heat is not lower than 120° C.

(6) The method of preparing food to be cooked under heat or food cooked under heat according to item (5), wherein the cooking under heat is carried out by frying, stir-frying or roasting.

(7) The method of preparing food to be cooked under heat or food cooked under heat according to any one of items (1) to (6), wherein the food is selected from the group consisting of noodles, tempura (Japanese deep-fried food), baked confectionery, fried confectionery, snacks and foods having wrapping sheet of dough made of a cereal flour or starch.

(8) The method of preparing food to be cooked under heat or food cooked under heat according to any one of items (1) to (7), wherein the food is to be cooked or cooked at a temperature for a period of time which permit the amount of acrylamide to be increased after the cooking under heat, compared with the amount of acrylamide contained in the food before the cooking under heat, in the case where the food to which the compound and/or the peptide complex is not added, is cooked under heat.

(9) The method of preparing food to be cooked under heat according to any one of items (1) to (8), wherein the method does not comprise final cooking of the food under heat for serving to eat to which the compound and/or the peptide complex is added, thereby to prepare semi-cooked food.

(10) The method of preparing food cooked under heat according to any one of items (1) to (8), wherein the method further comprises cooking the food to which the compound and/or the peptide complex is added, by cooking under heat thereby to prepare the food cooked under heat.

(11) Food before cooking under heat, which is prepared by the method defined in any of items (1) to (9), and which is capable of lowering acrylamide contained in the food after the cooking under heat.

(12) Food cooked under heat, which is prepared by the method defined in any of items (1) to (8) and (10), and in which acrylamide was lowered.

Additional objects and advantages of the present invention will be set forth in the description which follows, and in part will be obvious from the description, or may be learned by practice of the present invention. The objects and advantages of the present invention may be realized and obtained by means of the instrumentalities and combinations particularly pointed out hereinafter.

### BRIEF DESCRIPTION OF THE SEVERAL VIEWS OF THE DRAWING

The single FIGURE is a flowchart showing the outline of the model test for suppressing the acrylamide formation.

### DETAILED DESCRIPTION OF THE INVENTION

The preparation method of food to be cooked under heat or food cooked under heat of the present invention (hereinafter referred to as the method of the present invention) which permits lowering the acrylamide content, will now be described in detail. In the following description, the term “food cooked under heat” includes the food that is to be cooked under heat, i.e., the food before the cooking under heat, and the food cooked under heat unless otherwise specified.

One of the characteristic features of the method of the present invention for preparing the food cooked under heat is that at least one compound belonging to (a1) a neutral amino acid or a salt thereof, (a2) a basic amino acid or a salt thereof, (a3) a neutral imino acid or a salt thereof, (b) a sulfonic acid or a salt thereof and/or at least one peptide complex having, as a constituting component, one of the amino acids (a1) to (a3), is added to the food before the cooking under heat. Hereinafter the compound and the peptide complex are referred to as “additives of the present invention”.

The classification of the components used in the present invention into (a1) to (a3) are made with attention paid to the chemical structure of the amino acid, which has a carboxyl group and an amino group in the molecule. It should be noted that the amino acids and the sulfonic acid of component (b) used in the method of the present invention can also be classified by another criteria as will be described later.

Where attention is paid to the chemical structure, the amino acids are said to be classified into (1) a neutral amino acid, (2) a basic amino acid, (3) a neutral imino acid, (4) an acidic amino acid, and (5) an acid amide. Further, the neutral amino acid (1) can be classified into (1-1) a polar neutral amino acid and (1-2) a nonpolar neutral amino acid.

Components (a1) used in the present invention are those belonging to the neutral amino acid or a salt thereof (1). As described above, the neutral amino acid (1) can be further classified into the polar neutral amino acid (1-1), and the nonpolar neutral amino acid (1-2). To be more specific, the polar neutral amino acid (1-1) includes a hydroxyamino acid having a hydroxyl group within the molecular structure (such as serine or threonine), a sulfur-containing amino acid having a thiol group, a sulfide linkage or a disulfide linkage within the molecular structure (such as cysteine, cystine, or methionine), and an aromatic amino acid having an aromatic group within the molecular structure (such as tyrosine, tryptophan, or phenyl alanine), though the polar neutral amino acid (1-1) used in the present invention is not limited to the compounds exemplified above. On the other hand, the nonpolar neutral amino acid used in the present invention includes glycine, alanine, valine, leucine, isoleucine and γ-aminobutylic acid (GABA), though the nonpolar neutral amino acid used in the present invention is not limited to the compounds exemplified above.

It is desirable to use glycine or alanine as component (a1) in view of the effect of lowering acrylamide of the food after the cooking under heat, the convenience in handling including the solubility, and the taste of the cooked food.

The components (a2) used in the method of the present invention are those belonging to (2) a basic amino acid or a salt thereof. To be more specific, the basic amino acid (a2) used in the present invention includes lysine, arginine, histidine and ornithine, though the basic amino acid (a2) used in the present invention is not limited to the compounds exemplified above. It is desirable for the component (a2) to be lysine in view of, for example, the effect of decreasing the acrylamide content, in the convenience in handling such as the solubility, and in view of the taste.

The components (a3) used in the method of the present invention are those belonging to (3) a neutral imino acid or a salt thereof. To be more specific, the component (a3) noted above includes proline and hydroxyproline, though the component (a3) is not limited to these compounds. It is desirable for the component (a3) to be proline in view of, for example, the effect of decreasing the acrylamide content, in the convenience in handling such as the solubility, and in view of the taste.

The sulfonic acid or a salt thereof constituting the component (b) used in the method of the present invention is the sulfonic acid represented by the general structural formula RSO₃H, where R represents an amino group or an aliphatic or aromatic hydrocarbon, or a salt thereof. Where R in the general formula represents an aliphatic or aromatic hydrocarbon, it is desirable for at least one amino group to be substituted on R. It is preferable for R to be an aliphatic hydrocarbon having at least one amino group substituted thereon. The number of carbon atoms included in the aliphatic hydrocarbon is not particularly limited, but is preferably 0 to 2. It is desirable for the component (b) to be taurine in view of, for example, the effect of decreasing the acrylamide content, in the convenience in handling such as the solubility, and in view of the taste.

As described above, the additives used in the method of the present invention can also be classified with attention paid to another structural feature of the compounds in addition to the classifying criteria described above. For example, it is preferable that, among the amino acids, to use an amino acid in which the substituent bonded to the carbon atom having a carboxyl group bonded thereto (i.e., α-carbon) is a hydrogen atom (e.g., glycine), or a relatively short alkyl group (e.g., the alkyl group bonded to the α-carbon noted above has one carbon atom in alanine, serine, cystine and asparagines). This feature may also be applies to the case where sulfonic acid has an amino group. In other words, it is desirable for the substituent bonded to the carbon atom having the sulfonic group bonded thereto to be a relatively short alkyl group. For example, the alkyl group bonded to the carbon atom having the sulfonic group bonded thereto has one carbon atom in taurine. Also, when it comes to the amino acid belonging to the basic amino acid, it is desirable to use an amino acid having a linear structure such as lysine or arginine rather than an amino acid having a cyclic structure such as histidine.

In another point of view, the preferred amino acids referred to above have a high solubility to water, compared with other amino acids. It is desirable for the additives used in the present invention to have a solubility to water of at least 100 mg/100 g of water (25° C.) in terms of the convenience in handling of the additives.

The additives of the present invention can be used singly or at least two kinds of the additives may be used.

The above-described additives may be used in the form of a salt as long as such a salt, when added to the food, performs the desired function. The salts of the additives include an acid salt such as hydrochloride and sulfate, salts of alkali metals such as sodium and potassium, and amino acid salt, though the salts used in the present invention are not limited to these. The amino acid salt referred to above denotes a salt formed between the amino acid included in the components (a1) to (a3) referred to above and another amino acid. The other amino acid referred to above need not be selected from the components (a1) to (a3) and can be, for example, glutamic acid and asparaginic acid. Specific examples of the amino acid salt includes, for example, L-arginineL-glutamate and L-lysineL-glutamate, though the specific amino acid salt used in the present invention is not limited to these.

The peptide complex has, as a constituting component, at least one amino acid selected from (a1) to (a3), to which other amino acid(s) is (are) linked with a peptide linkage. The other amino acid(s) need not be selected from the amino acids of (a1) to (a3). Also, it is possible for a plurality of constituting amino acids to be the same kind or different kinds. Further, it is possible for the peptide complex used in the present invention to include linkages other than the peptide linkage. For example, it is possible for the peptide complex to include an ester linkage, ether linkage, and disulfide linkage. The number of amino acid residues of the peptide complex is not particularly limited as far as the peptide complex performs the function of decreasing acrylamide contained in the cooked food.

The peptide complex that can be used in the present invention includes, for example, glutathione and polylysine. Incidentally, polylysine available on the market generally has 25 to 30 amino acid residues. However, the peptide complex that can be used in the present invention is not limited to these.

The additive used in the present invention is not particularly limited in respect of the steric structure (e.g., D-body, L-body, α-body or γ-body) as far as the addition of the additive permits lowering acrylamide of the cooked food.

Further, amino acids, sulfonic acids and derivatives thereof other than those exemplified above can also be used in the present invention as far as these amino acids, sulfonic acids and derivatives thereof have the properties of any of the classifying criteria described above.

However, since the additives of the present invention are used in a food, it is needless to say, that preferable additives are not only selected from those having an enhanced ability of lowering the acrylamide of the cooked food, but also are selected in view of, for example, the solubility to water, color, taste, odor and cost in accordance with the food to which the additives are added.

The food to which the method of the present invention can be applied is not particularly limited as far as, when the additive of the invention is not used, acrylamide is generated by the cooking under heat. For example, the method of the present invention can be applied to the food containing cereal flours (such as wheat flour (e.g., strong flour, mellower strong flour, medium flour, soft flour and durum semolina), as well as buckwheat flour, rice powder), potatoes (e.g., white potatoes), and corn.

The particular foods cooked under heat include, for example, noodles (such as instant fried noodles, Yakisoba (stir-fried noodles or chow main), Ageyakisoba (fried and stir-fried noodles) and Yakiudon (stir-fried Japanese wheat noodle), tempura (Japanese deep-fried food), baked confectionery (such as cookies, biscuits, crackers, and Mugikogashi (scorched wheat)), fried confectionery (such as doughnuts, Karintou (fried dough cake), Imokempi (fried dough cake made of sweet potatoes)), snacks (such as potato chips, fried potatoes (French frier), corn snacks, almonds, and bean snacks), Chinese foods having wrapping sheet of dough made of a cereal flour or starch (such as Agegyouza (fried dumpling stuffed with minced pork), Yakigyouza (pan-broiled dumpling stuffed with minced pork), Agesyumai (fried shao-mai), Yakisyumai (pan-broiled shao-mai), fried spring roll, and fried won-ton), kneaded food products (such as Satsuma-age (fried fish cakes) and Chikuwa (fish paste)), teas (such as roasted tea, barley tea, coffee and cocoa), cereals, onion (such as a fried onion and roasted onion), and roasted sesame seeds, though the foods cooked under heat, to which the additive components of the present invention are applied, are not limited to these. Note that Ageyakisoba means hard-type Yakisoba, usually served to eat by sufficiently deep-frying Chinese noodle, which noodle may be raw, steamed or boiled, on which viscous sauce containing stir-fried ingredients, such as sea food, meat and vegetables, are poured, although Ageyakisoba is not limited to this.

Among the foods exemplified above, it is especially appropriate to apply the method of the present invention to, so-called “semi-cooked foods”, i.e., semi-cooked food before the final cooking under heat. Semi-cooked foods include food to which cutting and molding, etc., has been applied, as required, but cooking under heat has not yet been applied, and food to which cutting and molding, etc., has been applied, as required, and a preliminary cooking under heat has also been applied. These semi-cooked foods are subjected to heat treatment under temperatures not lower than 120° C. for preparation of the cooked food.

The semi-cooked foods include, for example, Yakisoba, which is before the final cooking of stir-frying, Yakigyouza, which is dumpling stuffed with minced pork before the final cooking, i.e., pan-broiling), potatoes for French frier, which are cut or molded after mashing, frozen pie dough, and frozen bread dough, though the semi-cooked foods to which the present invention is applied are not limited to these.

In the method of the present invention, the amount of the additive is not particularly limited as far as the amount of acrylamide contained in the food cooked under heat, to which the additive component is added, is lowered compared with the case where the additive of the present invention is not added to the food. The amount of the additives may be decided appropriately depending on the kind of the food to which the additive is added, the heating temperature and the heating time for the cooking, the kind of the additive, the solubility of the additive compound, and the effect of decreasing acrylamide of the food after the cooking under heat. In view of the effect of decreasing acrylamide of the food after cooking under heat, it is desirable for the additive to be used in a large amount. However, where the additive itself has a taste and/or a color, it is desirable to determine the amount of the additive in view of, for example, the balance with the capability of maintaining the quality as the food. It is practical to use the additive in an amount of 0.01 to 5% by weight based on the amount of the raw material.

It should be noted that there is a case where the additives specified in the present invention are originally contained in the food to which the method of the present invention is applied, and another case where the additives specified in the present invention are formed during the cooking process under heat. In such a case, the amount of the additive originally contained in the food or formed during the cooking process under heat can be subtracted from the addition amount of the additive component.

The food to which the method of the present invention is applied may be cooked in a conventional method, except that the additive of the present invention is added to the food before the cooking under heat.

In the method of the present invention, the method of adding the additives to the food is not particularly limited. It is possible to select appropriately the method of adding the additive in accordance with the state of the food to which the additive is added and in accordance with the preparation process. For example, where the food, to which the additive component is added, is a solid material like potatoes used for the preparation of potato chips, it is possible to use the additive as an aqueous solution, and the additive can be added to the food by means of coating, dipping or showering. On the other hand, where the food, to which the additive component of the present invention is added, is a semi-solid material or a material having high fluidity such as a noodle dough or a dough for the baked confectionery, it is possible to knead an aqueous solution of the additive into the dough or to apply the aqueous solution by means of the showering, spraying or coating. The number of adding operations is not particularly limited either. It is possible to add the additive only once or in a plurality of times during the preparation process. Incidentally, where the additive of the present invention is added by means of, for example, showering, spraying, or coating of an aqueous solution, the weights of the food before and after the application are measured and the addition amount is generally calculated from the difference in the measured weight between the food before and after the addition of the additive. It is also possible to measure the addition amount of the additive by using, for example, an amino acid analyzing apparatus.

The timing at which the additive is added to the food is not particularly limited as far as the additive is added before the cooking of the food under heat. It is possible to add the additive at an appropriate timing during the cooking process of the food. When it comes to noodles, the additive may be added during the kneading process of the noodle dough, or may be coated to noodles together with a seasoning component in the seasoning process. Also, when it comes to the baked confectionery such as cookies, the additive may be added in the kneading process of the dough or may be coated during the molding process.

In the method of the present invention, it is possible to set the heating temperature and time for the heating at those applied in general to the food to which the present invention is applied. Needless to say, the method of the present invention is applied to the case where acrylamide is generated by cooking under heat that is carried out to the food. The temperature at which acrylamide is generated during the heating of the food is said to be relatively high, i.e., about 120° C. or higher. In the cooking of the food under heat, such a temperature condition arises, in general, during frying, which is generally carried out at 120 to 200° C., and during baking within an oven, which is generally carried out at 130 to 280° C., though the cooking process during which acrylamide generates is not limited to the frying and the baking pointed out above. It is known to the art that acrylamide formed under temperatures not lower than 180° C. is partly decomposed. It should be noted that the amount of acrylamide generated during the cooking is generally said to be increased with increase in the heating time.

The present invention also provides the food before the cooking under heat, which is prepared by the method of the present invention and which permits decreasing acrylamide, and the food after the cooking under heat, which has lowered acrylamide.

In the present invention, the food with lowered acrylamide is achieved by using the additive of the invention before cooking under heat. The food with lowered acrylamide denotes the food containing acrylamide lower than that of the same food, except that the additive is not added.

### EXAMPLES

Some Examples of the present invention will now be described, though the present invention is not limited to these Examples.

In the following Examples, the expression “%” denotes “% by weight”.

Comparative Example 1 described below and Examples 1 to 10 are the comparative example and the example of the present invention in which the methods of the present invention are applied to fried noodles, respectively.

### Comparative Example 1

Five kg of wheat flour, and 1.6 kg of water, to which 76 g of salt and 16.4 g of “kansui” were added and stirred, were charged to a mixer and kneaded for 18 minutes so as to obtain noodle dough. “Kansui” used in comparative examples and examples hereinafter contains potassium carbonate, sodium carbonate, and etc.

The noodle dough thus obtained was stretched using rollers by the ordinary method so as to obtain a dough sheet having a thickness of 0.77 mm and, then, the dough sheet was cut by a square cutting roll No. 20 so as to obtain strands of the noodle having a width of 1.5 mm.

These strands of noodle were steamed for 90 seconds by the ordinary method, followed by spraying a seasoning solution (pH 6.80) containing 5.72% of salt and 1.34% of sodium glutamate.

Further, these strands of noodle were cut into a prescribed length and shaped into a molding block, followed by frying the cut strands of noodle at 150° C. for 120 seconds with palm oil, thereby obtaining fried noodles. Then, the fried noodles were put in a cup, followed by housing a soup into the cup and subsequently sealing the cup so as to obtain instant fried noodles placed in the cup.

### Example 1

Five kg of wheat flour, and 1.6 kg of water, to which 76 g of salt, 16.4 g of “kansui” and 15 g of glycine were added and stirred, were charged to a mixer and kneaded for 18 minutes so as to obtain noodle dough.

The noodle dough thus obtained was stretched using rollers by the ordinary method so as to obtain a dough sheet having a thickness of 0.77 mm and, then, the dough sheet was cut by a square cutting roll No. 20 so as to obtain strands of the noodle having a width of 1.5 mm.

These strands of noodle were steamed for 90 seconds by the ordinary method, followed by spraying a seasoning solution (pH 6.80) containing 5.72% of salt and 1.34% of sodium glutamate.

Further, these strands of noodle were cut into a prescribed length and shaped into a molding block, followed by frying the cut strands of noodle at 150° C. for 120 seconds with palm oil, thereby obtaining fried noodles. Then, the fried noodles were put in a cup, followed by housing a soup into the cup and subsequently sealing the cup so as to obtain instant fried noodles placed in the cup.

### Example 2

Five kg of wheat flour, and 1.6 kg of water, to which 76 g of salt and 16.4 g of “kansui” were added and stirred, were charged to a mixer and kneaded for 18 minutes so as to obtain noodle dough.

The noodle dough thus obtained was stretched using rollers by the ordinary method so as to obtain a dough sheet having a thickness of 0.77 mm and, then, the dough sheet was cut by a square cutting roll No. 20 so as to obtain strands of the noodle having a width of 1.5 mm.

These strands of noodle were steamed for 90 seconds by the ordinary method, followed by spraying a seasoning solution (pH 6.73) containing 5.72% of salt, 1.34% of sodium glutamate and 1% of glycine.

Further, these strands of noodle were cut into a prescribed length and shaped into a molding block, followed by frying the cut strands of noodle at 150° C. for 120 seconds with palm oil, thereby obtaining fried noodles. Then, the fried noodles were put in a cup, followed by housing a soup into the cup and subsequently sealing the cup so as to obtain instant fried noodles placed in the cup.

### Example 3

Five kg of wheat flour, and 1.6 kg of water, to which 76 g of salt, 16.4 g of “kansui” and 15 g of L-lysine hydrochloride were added and stirred, were charged to a mixer and kneaded for 18 minutes so as to obtain noodle dough.

The noodle dough thus obtained was stretched using rollers by the ordinary method so as to obtain a dough sheet having a thickness of 0.77 mm and, then, the dough sheet was cut by a square cutting roll No. 20 so as to obtain strands of the noodle having a width of 1.5 mm.

These strands of noodle were steamed for 90 seconds by the ordinary method, followed by spraying a seasoning solution (pH 6.80) containing 5.72% of salt and 1.34% of sodium glutamate.

Further, these strands of noodle were cut into a prescribed length and shaped into a molding block, followed by frying the cut strands of noodle at 150° C. for 120 seconds with palm oil, thereby obtaining fried noodles. Then, the fried noodles were put in a cup, followed by housing a soup into the cup and subsequently sealing the cup so as to obtain instant fried noodles placed in the cup.

### Example 4

Instant fried noodles in a cup were prepared in the same manner as in Example 2, except that a seasoning solution (pH 6.66) containing 5.72% of salt, 1.34% of sodium glutamate and 1% of L-lysine hydrochloride was used.

### Example 5

Five kg of wheat flour, and 1.6 kg of water, to which 76 g of salt, 16.4 g of “kansui” and 15 g of taurine were added and stirred, were charged to a mixer and kneaded for 18 minutes so as to obtain noodle dough.

The noodle dough thus obtained was stretched using rollers by the ordinary method so as to obtain a dough sheet having a thickness of 0.77 mm and, then, the dough sheet was cut by a square cutting roll No. 20 so as to obtain strands of the noodle having a width of 1.5 mm.

These strands of noodle were steamed for 90 seconds by the ordinary method, followed by spraying a seasoning solution (pH 6.80) containing 5.72% of salt and 1.34% of sodium glutamate.

Further, these strands of noodle were cut into a prescribed length and shaped into a molding block, followed by frying the cut strands of noodle at 150° C. for 120 seconds with palm oil, thereby obtaining fried noodles. Then, the fried noodles were put in a cup, followed by housing a soup into the cup and subsequently sealing the cup so as to obtain instant fried noodles placed in the cup.

### Example 6

Five kg of wheat flour, and 1.6 kg of water, to which 76 g of salt, 16.4 g of “kansui” and 25 g of β-alanine were added and stirred, were charged to a mixer and kneaded for 18 minutes so as to obtain noodle dough.

The noodle dough thus obtained was stretched using rollers by the ordinary method so as to obtain a dough sheet having a thickness of 0.77 mm and, then, the dough sheet was cut by a square cutting roll No. 20 so as to obtain strands of the noodle having a width of 1.5 mm.

These strands of noodle were steamed for 90 seconds by the ordinary method, followed by spraying a seasoning solution (pH 6.80) containing 5.72% of salt and 1.34% of sodium glutamate.

Further, these strands of noodle were cut into a prescribed length and shaped into a molding block, followed by frying the cut strands of noodle at 150° C. for 120 seconds with palm oil, thereby obtaining fried noodles. Then, the fried noodles were put in a cup, followed by housing a soup into the cup and subsequently sealing the cup so as to obtain instant fried noodles placed in the cup.

### Example 7

Five kg of wheat flour, and 1.6 kg of water, to which 76 g of salt, 16.4 g of “kansui” and 25 g of γ-aminobutylic acid (GABA) were added and stirred, were charged to a mixer and kneaded for 18 minutes so as to obtain noodle dough.

The noodle dough thus obtained was stretched using rollers by the ordinary method so as to obtain a dough sheet having a thickness of 0.77 mm and, then, the dough sheet was cut by a square cutting roll No. 20 so as to obtain strands of the noodle having a width of 1.5 mm.

These strands of noodle were steamed for 90 seconds by the ordinary method, followed by spraying a seasoning solution (pH 6.80) containing 5.72% of salt and 1.34% of sodium glutamate.

Further, these strands of noodle were cut into a prescribed length and shaped into a molding block, followed by frying the cut strands of noodle at 150° C. for 120 seconds with palm oil, thereby obtaining fried noodles. Then, the fried noodles were put in a cup, followed by housing a soup into the cup and subsequently sealing the cup so as to obtain instant fried noodles placed in the cup.

### Example 8

Five kg of wheat flour, and 1.6 kg of water, to which 76 g of salt, 16.4 g of “kansui” and 15 g of L-lysineL-glutamate were added and stirred, were charged to a mixer and kneaded for 18 minutes so as to obtain noodle dough.

The noodle dough thus obtained was stretched using rollers by the ordinary method so as to obtain a dough sheet having a thickness of 0.77 mm and, then, the dough sheet was cut by a square cutting roll No. 20 so as to obtain strands of the noodle having a width of 1.5 mm.

These strands of noodle were steamed for 90 seconds by the ordinary method, followed by spraying a seasoning solution (pH 6.80) containing 5.72% of salt and 1.34% of sodium glutamate.

Further, these strands of noodle were cut into a prescribed length and shaped into a molding block, followed by frying the cut strands of noodle at 150° C. for 120 seconds with palm oil, thereby obtaining fried noodles. Then, the fried noodles were put in a cup, followed by housing a soup into the cup and subsequently sealing the cup so as to obtain instant fried noodles placed in the cup.

### Example 9

Instant fried noodles in a cup were prepared in the same manner as in Example 2, except that a seasoning solution (pH 4.35) containing 5.72% of salt, 1.34% of sodium glutamate and 1% of glutathione was used.

### Example 10

Five kg of wheat flour, and 1.6 kg of water, to which 76 g of salt, 16.4 g of “kansui” and 15 g of polylysine were added and stirred, were charged to a mixer and kneaded for 18 minutes so as to obtain noodle dough.

The noodle dough thus obtained was stretched using rollers by the ordinary method so as to obtain a dough sheet having a thickness of 0.77 mm and, then, the dough sheet was cut by a square cutting roll No. 20 so as to obtain strands of the noodle having a width of 1.5 mm.

These strands of noodle were steamed for 90 seconds by the ordinary method, followed by spraying a seasoning solution (pH 6.80) containing 5.72% of salt and 1.34% of sodium glutamate.

Further, these strands of noodle were cut into a prescribed length and shaped into a molding block, followed by frying the cut strands of noodle at 150° C. for 120 seconds with palm oil, thereby obtaining fried noodles. Then, the fried noodles were put in a cup, followed by housing a soup into the cup and subsequently sealing the cup so as to obtain instant fried noodles placed in the cup.

Comparative Example 2 described below and Examples 11 to 14 are the comparative example and the example of the present invention in which the methods of the present invention are applied to another style of fried noodles, respectively.

### Comparative Example 2

Five kg of wheat flour, and 1.6 kg of water, to which 76 g of salt and 30.0 g of phosphate, were charged to a mixer and kneaded for 18 minutes so as to obtain noodle dough.

The noodle dough thus obtained was stretched using rollers by the ordinary method so as to obtain a dough sheet having a thickness of 0.70 mm and, then, the dough sheet was cut by a square cutting roll No. 12 so as to obtain strands of the noodle having a width of 2.5 mm.

These strands of noodle were steamed for 90 seconds by the ordinary method, followed by spraying a seasoning solution (pH 6.80) containing 5.72% of salt and 1.34% of sodium glutamate.

Further, these strands of noodle were cut into a prescribed length and shaped into a molding block, followed by frying the cut strands of noodle at 150° C. for 120 seconds with palm oil, thereby obtaining fried noodles. Then, the fried noodles were put in a cup, followed by housing a soup into the cup and subsequently sealing the cup so as to obtain instant fried noodles placed in the cup.

### Example 11

Five kg of wheat flour, and 1.6 kg of water, to which 76 g of salt and 30.0 g of phosphate were added and stirred, were charged to a mixer and kneaded for 18 minutes so as to obtain noodle dough.

The noodle dough thus obtained was stretched using rollers by the ordinary method so as to obtain a dough sheet having a thickness of 0.70 mm and, then, the dough sheet was cut by a square cutting roll No. 12 so as to obtain strands of the noodle having a width of 2.5 mm.

These strands of noodle were steamed for 90 seconds by the ordinary method, followed by spraying a seasoning solution (pH 6.73) containing 5.72% of salt, 1.34% of sodium glutamate and 1% of glycine.

Further, these strands of noodle were cut into a prescribed length and shaped into a molding block, followed by frying the cut strands of noodle at 150° C. for 120 seconds with palm oil, thereby obtaining fried noodles. Then, the fried noodles were put in a cup, followed by housing a soup into the cup and subsequently sealing the cup so as to obtain instant fried noodles placed in the cup.

### Example 12

Instant fried noodles in a cup were prepared in the same manner as in Example 11, except that a seasoning solution (pH 6.60) containing 5.72% of salt, 1.34% of sodium glutamate and 1% of taurine was used.

### Example 13

Five kg of wheat flour, and 1.6 kg of water, to which 76 g of salt, 30.0 g of phosphate and 10 g of glycine were added and stirred, were charged to a mixer and kneaded for 18 minutes so as to obtain noodle dough.

The noodle dough thus obtained was stretched using rollers by the ordinary method so as to obtain a dough sheet having a thickness of 0.70 mm and, then, the dough sheet was cut by a square cutting roll No. 12 so as to obtain strands of the noodle having a width of 2.5 mm.

These strands of noodle were steamed for 90 seconds by the ordinary method, followed by spraying a seasoning solution (pH 6.80) containing 5.72% of salt and 1.34% of sodium glutamate.

Further, these strands of noodle were cut into a prescribed length and shaped into a molding block, followed by frying the cut strands of noodle at 150° C. for 120 seconds with palm oil, thereby obtaining fried noodles. Then, the fried noodles were put in a cup, followed by housing a soup into the cup and subsequently sealing the cup so as to obtain instant fried noodles placed in the cup.

### Example 14

Five kg of wheat flour, and 1.6 kg of water, to which 76 g of salt, 30.0 g of phosphate and 25 g of L-lysine hydrochloride were added and stirred, were charged to a mixer and kneaded for 18 minutes so as to obtain noodle dough.

The noodle dough thus obtained was stretched using rollers by the ordinary method so as to obtain a dough sheet having a thickness of 0.70 mm and, then, the dough sheet was cut by a square cutting roll No. 12 so as to obtain strands of the noodle having a width of 2.5 mm.

These strands of noodle were steamed for 90 seconds by the ordinary method, followed by spraying a seasoning solution (pH 6.80) containing 5.72% of salt and 1.34% of sodium glutamate.

Further, these strands of noodle were cut into a prescribed length and shaped into a molding block, followed by frying the cut strands of noodle at 150° C. for 120 seconds with palm oil, thereby obtaining fried noodles. Then, the fried noodles were put in a cup, followed by housing a soup into the cup and subsequently sealing the cup so as to obtain instant fried noodles placed in the cup.

Comparative Example 3 described below and Examples 15 to 17 are the comparative example and the example of the present invention in which the methods of the present invention are applied to tempura or Kakiage (deep-fried mixture of ingredients such as vegetable, fish and etc.), respectively.

### Comparative Example 3

Three hundred g of wheat flour, 6 g of salt, 1.5 g of the whole egg powder and 1.2 g of a baking powder were added to 600 g of water, and stirred to prepare batter for Kakiage.

Then, a prescribed amount of the batter for Kakiage was fried at 170° C. for 3 minutes with palm oil thereby to obtain batter of Kakiage.

### Example 15

Three hundred g of wheat flour, 6 g of salt, 1.5 g of the whole egg powder, 1.2 g of a baking powder and 1.5 g of glycine were added to 600 g of water, and stirred to prepare batter for Kakiage.

Then, a prescribed amount of the batter for Kakiage was fried at 170° C. for 3 minutes with palm oil thereby to obtain batter for Kakiage.

### Example 16

Three hundred g of wheat flour, 6 g of salt, 1.5 g of the whole egg powder, 1.2 g of a baking powder and 1.5 g of L-lysine hydrochloride were added to 600 g of water, and stirred to prepare batter for Kakiage.

Then, a prescribed amount of the batter for Kakiage was fried at 170° C. for 3 minutes with palm oil thereby to obtain the batter for Kakiage.

### Example 17

Three hundred g of wheat flour, 6 g of salt, 1.5 g of the whole egg powder, 1.2 g of a baking powder and 1.5 g of taurine were added to 600 g of water, and stirred to prepare batter for Kakiage.

Then, a prescribed amount of the batter for Kakiage was fried at 170° C. for 3 minutes with palm oil thereby to obtain the batter for Kakiage.

Table 1 shows the blending conditions, the other preparation conditions, and the acrylamide content (ppb) of the fried noodles prepared in Comparative Example 1, Examples 1 to 10 of the present invention. Table 2 shows the blending conditions, the other preparation conditions, and the acrylamide content (ppb) of the fried noodles prepared in Comparative Example 2 and Examples 11 to 14 of the present invention. Further, Table 3 shows the blending conditions, the other preparation conditions, and the acrylamide content (ppb) of tempura (or Kakiage) prepared in Comparative Example 3 and Examples 15 to 17 of the present invention. The measuring method of acrylamide (AA) content of the fried noodles will be described herein later.

TABLE 1

| | Comp. | Exam- | Exam- | Exam- | Exam- | Exam- |
|---|---|---|---|---|---|---|
| | 1 | ple 1 | ple 2 | ple 3 | ple 4 | ple 5 |
| Blending | | | | | | |
| condition | | | | | | |
| <Main raw | | | | | | |
| material> | | | | | | |
| Wheat flour | 5.0 kg | 5.0 kg | 5.0 kg | 5.0 kg | 5.0 kg | 5.0 kg |
| <Sub-raw | | | | | | |
| material> | | | | | | |
| Refined salt | 76 g | 76 g | 76 g | 76 g | 76 g | 76 g |
| “Kansui” | 16.4 g | 16.4 g | 16.4 g | 16.4 g | 16.4 g | 16.4 g |
| Glycine | — | 15 g | — | — | — | — |
| L-lysine | — | — | — | 15 g | — | — |
| hydrochloride | | | | | | |
| Taurine | — | — | — | — | — | 15 g |
| <Seasoning | | | | | | |
| component> | | | | | | |
| Refined salt | 57.2 g | 57.2 g | 57.2 g | 57.2 g | 57.2 g | 57.2 g |
| Sodium | 13.4 g | 13.4 g | 13.4 g | 13.4 g | 13.4 g | 13.4 g |
| glutamate | | | | | | |
| Glycine | — | — | 10 g | — | — | — |
| L-Lysine | — | — | — | — | 10 g | — |
| hydrochloride | | | | | | |
| Water | 1.0 L | 1.0 L | 1.0 L | 1.0 L | 1.0 L | 1.0 L |
| Analyzed | 100 | 32 | 50 | 62 | 64 | 34 |
| AA value (ppb) | | | | | | |

| | Exam- | Exam- | Exam- | Exam- | Exam- |
|---|---|---|---|---|---|
| | ple 6 | ple 7 | ple 8 | ple 9 | ple 10 |
| Blending condition | | | | | |
| <Main raw material> | | | | | |
| Wheat flour | 5.0 kg | 5.0 kg | 5.0 kg | 5.0 kg | 5.0 kg |
| <Sub-raw material> | | | | | |
| Refined salt | 76 g | 76 g | 76 g | 76 g | 76 g |
| “Kansui” | 16.4 g | 16.4 g | 16.4 g | 16.4 g | 16.4 g |
| β-Alanine | 25 g | — | — | — | — |
| γ-Aminobtyric acid | — | 25 g | — | — | — |
| L-LysineL-glutamate | — | — | 15 g | — | — |
| Polylysine | — | — | — | — | 15 g |
| <Seasoning component> | | | | | |
| Refined salt | 57.2 g | 57.2 g | 57.2 g | 57.2 g | 57.2 g |
| Sodium glutamate | 13.4 g | 13.4 g | 13.4 g | 13.4 g | 13.4 g |
| Glutathione | — | — | — | 10 g | — |
| Water | 1.0 L | 1.0 L | 1.0 L | 1.0 L | 1.0 L |
| Analyzed AA | 26 | 36 | 72 | 59 | 62 |
| value (ppb) | | | | | |

TABLE 2

| | Comp. 2 | Example 11 | Example 12 | Example 13 | Example 14 |
|---|---|---|---|---|---|
| Blending condition | | | | | |
| <Main raw material> | | | | | |
| Wheat flour | 5.0 kg | 5.0 kg | 5.0 kg | 5.0 kg | 5.0 kg |
| <Sub-raw material> | | | | | |
| Refined salt | 76 g | 76 g | 76 g | 76 g | 76 g |
| Phosphate | 30.0 g | 30.0 g | 30.0 g | 30.0 g | 30.0 g |
| Glycine | — | — | — | 10 g | — |
| L-Lysine hydrochloride | — | — | — | — | 25 g |
| <Seasoning component> | | | | | |
| Refined salt | 57.2 g | 57.2 g | 57.2 g | 57.2 g | 57.2 g |
| Sodium glutamate | 13.4 g | 13.4 g | 13.4 g | 13.4 g | 13.4 g |
| Glycine | — | 10 g | — | — | — |
| Taurine | — | — | 10 g | — | — |
| Water | 1.0 L | 1.0 L | 1.0 L | 1.0 L | 1.0 L |
| Analyzed AA value (ppb) | 48 | 25 | 23 | 21 | 34 |

TABLE 3

| | Comp. | Example | Example | Example |
|---|---|---|---|---|
| | 3 | 15 | 16 | 17 |
| Blending condition | | | | |
| <Main raw material> | | | | |
| Wheat flour | 300 g | 300 g | 300 g | 300 g |
| <Seasoning component> | | | | |
| Refined salt | 6 g | 6 g | 6 g | 6 g |
| Whole egg powder | 1.5 g | 1.5 g | 1.5 g | 1.5 g |
| Baking powder | 1.2 g | 1.2 g | 1.2 g | 1.2 g |
| Glycine | — | 1.5 g | — | — |
| L-Lysine hydrochloride | — | — | 1.5 g | — |
| Taurine | — | — | — | 1.5 g |
| Analyzed AA value (ppb) | 106 | 40 | 69 | 45 |

As apparent from the results show in Tables 1 and 2, the addition of amino acids or sulfonic acid to the foods cooked under heat allowed effective decrease in acrylamide contained therein. Glycine and taurine were particularly effective for the instant fried noodles. In order to decrease acrylamide, the addition method of the amino acids or sulfonic acid may be either by way of kneading the amino acids or sulfonic acid as a sub-raw material into the noodle dough or by way of adding the amino acids or sulfonic acid into a seasoning solution and spraying the solution to the food.

Also, the results shown in Table 3 supports that the addition of the amino acids or sulfonic acid to the instant fried noodles and tempura (Kakiage) allowed effective decrease in acrylamide contained therein.

Comparative Example 4 and Examples 18 to 29 described below are a comparative example and examples of the present invention in which the methods of the present invention are applied to Ageyakisoba (fried and pan-broiled noodles), respectively. The results are shown herein later in Table 4.

### Comparative Example 4

Wheat flour in an amount of 2700 g, and 1020 g of water, to which 300 g of potato starch, 30 g of salt and 15 g of “kansui” were added and stirred, were charged to a mixer and kneaded for 10 minutes so as to obtain noodle dough.

The noodle dough thus obtained was stretched using rollers by the ordinary method so as to obtain a dough sheet having a thickness of 0.90 mm and, then, the dough sheet was cut by a square cutting roll No. 34 so as to obtain strands of the noodle having a width of 0.90 mm.

Further, these strands of noodle were cut into a prescribed length and shaped into a molding block, followed by frying the cut strands of noodle at 175° C. for 70 seconds with vegetable oil (80% of rape oil and 20% of palm oil), thereby obtaining Ageyakisoba. Then, the Ageyakisoba was wrapped in a shrink film and housed in an exclusive tray together with a soup, followed by wrapping the tray so as to prepare Ageyakisoba.

### Examples 18 to 29

Wheat flour in an amount of 2700 g, and 1020 g of water, to which 300 g of potato starch, 30 g of salt, 15 g of “kansui” and 15 g of each compound to be tested were added as shown in Table 4 and stirred, were charged to a mixer and kneaded for 10 minutes so as to obtain noodle dough, proved that L-serine, L-arginine and L-proline were used in amounts of 10 g, 10 g, and 6 g, respectively.

The noodle dough thus obtained was stretched using rollers by the ordinary method so as to obtain a dough sheet having a thickness of 0.90 mm and, then, the dough sheet was cut by a square cutting roll No. 34 so as to obtain strands of the noodle having a width of 0.90 mm.

Further, these strands of noodle were cut into a prescribed length and shaped into a molding block, followed by frying the cut strands of noodle at 175° for 70 seconds with vegetable oil (80% of rape oil and 20% of palm oil), thereby obtaining several kinds of Ageyakisoba. Then, the Ageyakisoba were wrapped in a shrink film and housed in an exclusive tray together with a soup, followed by wrapping the tray so as to prepare Ageyakisoba.

Table 4 shows the blending conditions and the acrylamide content (ppb) of the noodles prepared in Comparative Example 4 and Examples 18 to 29 of the present invention.

TABLE 4

| | Comp. | Exam- | Exam- | Exam- | Exam- | Exam- | Exam- |
|---|---|---|---|---|---|---|---|
| | 4 | ple 18 | ple 19 | ple 20 | ple 21 | ple 22 | ple 23 |
| Blending condition | | | | | | | |
| <Main raw material> | | | | | | | |
| Wheat flour | 2700 g | 2700 g | 2700 g | 2700 g | 2700 g | 2700 g | 2700 g |
| Potato starch | 300 g | 300 g | 300 g | 300 g | 300 g | 300 g | 300 g |
| <Sub-raw material> | | | | | | | |
| Refined salt | 30 g | 30 g | 30 g | 30 g | 30 g | 30 g | 30 g |
| “Kansui” | 15 g | 15 g | 15 g | 15 g | 15 g | 15 g | 15 g |
| Glycine | — | 15 g | — | — | — | — | — |
| L-Alanine | — | — | 15 g | — | — | — | — |
| L-Serine | — | — | — | 10 g | — | — | — |
| L-Lysine | — | — | — | — | 15 g | — | — |
| hydrochloride | | | | | | | |
| L-Arginine | — | — | — | — | — | 10 g | — |
| L-Histidine | — | — | — | — | — | — | 15 g |
| Water | 1020 g | 1020 g | 1020 g | 1020 g | 1020 g | 1020 g | 1020 g |
| Analyzed AA | 523 | 168 | 283 | 416 | 158 | 428 | 246 |
| value (ppb) | | | | | | | |

| | Exam- | Exam- | Exam- | Exam- | Example | Exam- |
|---|---|---|---|---|---|---|
| | ple 24 | ple 25 | ple 26 | ple 27 | 28 | ple 29 |
| Blending condition | | | | | | |
| <Main raw material> | | | | | | |
| Wheat flour | 2700 g | 2700 g | 2700 g | 2700 g | 2700 g | 2700 g |
| Potato starch | 300 g | 300 g | 300 g | 300 g | 300 g | 300 g |
| <Sub-raw material> | | | | | | |
| Refined salt | 30 g | 30 g | 30 g | 30 g | 30 g | 30 g |
| “Kansui” | 15 g | 15 g | 15 g | 15 g | 15 g | 15 g |
| L-Proline | 6 g | — | — | — | — | — |
| L-Hydroxyproline | — | 15 g | — | — | — | — |
| Taurine | — | — | 15 g | — | — | — |
| L-ArginineL-glutamate | — | — | — | 15 g | — | — |
| L-LysineL-glutamate | — | — | — | — | 15 g | — |
| Polylysine | — | — | — | — | — | 15 g |
| Water | 1020 g | 1020 g | 1020 g | 1020 g | 1020 g | 1020 g |
| Analyzed AA value (ppb) | 203 | 352 | 45 | 316 | 166 | 192 |

As apparent from the results shown in Table 4, the addition of the amino acids or sulfonic acid to Yakisoba allowed effective decrease in acrylamide contained therein. Glycine, L-lysine hydrochloride, taurine, and L-lysineL-glutamate were found to be particularly effective for decreasing acrylamide (AA). In other words, the use of these compounds provides methods of preparing Ageyakisoba with decreased acrylamide.

Comparative Example 5 and Examples 30 and 31 described below are a comparative example and examples of the present invention in which the methods of the present invention are applied to Agegyouza (pan-broiled dumping stuffed with minced pork). The results are shown herein later in Table 5.

### Comparative Example 5

Water in an amount of 1000 g, to which 1000 g of wheat flour and 10 g of salt were added and stirred, were charged to a mixer and kneaded for 12 minutes so as to obtain dough for wrapping Gyouza (dumpling stuffed with minced pork).

The dough thus obtained was stretched using rollers by the ordinary method so as to obtain a dough sheet having a thickness of 0.70 mm and, then, the dough sheet was cut out using a molding die (80 mm×88 mmφ) so as to obtain wrapping sheet of Gyouza.

In the next step, the stuffing of the Gyouza was prepared by kneading a mixture consisting of 700 g of minced pork, 1000 g of cabbage cut into tiny pieces each having a width of 5 mm, 20 g of cut leek pieces each having a width of 5 mm, and seasonings consisting of 18 g of salt, 2 g of pepper, 22 g of grated ginger, 14 g of grated garlic, 24 g of soy sauce, and 34 g of sesame oil. The mixture noted above was kneaded in a mixer for 5 minutes so as to obtain the stuffing of Gyouza.

The stuffing thus obtained was divided into small pieces each weighing 12.5 g, and each small piece was molded with the wrapping sheet mentioned above in a molding machine of Gyouza so as to obtain uncooked Gyouza. The uncooked pieces thus obtained were arrayed on an exclusive tray and steamed at 90° C. for 10 minutes, followed by cooling the steamed pieces of Gyouza and subsequently wrapping the cooled pieces in a wrapping sheet so as to obtain steamed Gyouza.

Further, the steamed Gyouza was fried at 175° C. for 2 minutes with a vegetable oil (corn salad oil) so as to obtain Agegyouza (fried Gyouza).

### Examples 30 and 31

Water in an amount of 340 g, to which 1000 g of wheat flour, 10 g of salt and 5 g of each compound to be tested were added as shown in Table 5 and stirred, were charged to a mixer and kneaded for 12 minutes so as to obtain dough for wrapping Gyouza.

The dough thus obtained was stretched using rollers by the ordinary method so as to obtain a dough sheet having a thickness of 0.70 mm and, then, the dough sheet was cut out using a molding die (80 mm×88 mmφ) so as to obtain wrapping sheet of Gyouza.

In the next step, the stuffing of Gyouza were prepared by kneading a mixture consisting of 700 g of minced pork, 1000 g of cabbage cut into tiny pieces each having a width of 5 mm, 20 g of cut leek pieces each having a width of 5 mm, and seasonings consisting of 18 g of salt, 2 g of pepper, 22 g of grated ginger, 14 g of grated garlic, 24 g of soy sauce, and 34 g of sesame oil. The mixture noted above was kneaded in a mixer for 5 minutes so as to obtain the stuffing of Gyouza.

The stuffing thus obtained was divided into small pieces each weighing 12.5 g, and each small piece was molded with the wrapping sheet mentioned above in a molding machine of Gyouza so as to obtain uncooked piece of Gyouza. The uncooked pieces thus obtained were arrayed on an exclusive tray and steamed at 90°C for 10 minutes, followed by cooling the steamed pieces of Gyouza and subsequently wrapping the cooled pieces in a wrapping sheet so as to obtain steamed Gyouza.

Further, the steamed Gyouza was fried at 175° C. for 2 minutes with a vegetable oil (corn salad oil) so as to obtain Agegyouza.

Table 5 shows the blending conditions of the wrapping sheet and the acrylamide content (ppb) of the fried Gyouza, which was prepared in Comparative Example 5 and Examples 30 and 31 of the present invention.

TABLE 5

| | Comp. 5 | Example 30 | Example 31 |
|---|---|---|---|
| Blending condition | | | |
| <Main raw material> | | | |
| Wheat flour | 1000 g | 1000 g | 1000 g |
| <Sub-raw material> | | | |
| Refined salt | 10 g | 10 g | 10 g |
| Glycine | — | 5 g | — |
| L-Cysteine | — | — | 5 g |
| hydrochloride | | | |
| Water | 340 g | 340 g | 340 g |
| Analyzed AA value (ppb) | 38 | 27 | 21 |

As apparent from the results shown in Table 5, the addition of glycine or L-cysteine hydrochloride to the wrapping sheet allowed effective decrease in acrylamide contained therein. In other words, the use of these compounds provides a method of preparing Agegyouza with decreased acrylamide.

Examples 32 to 33 are examples of the present invention, in which the methods of the present invention are applied to potato chips and biscuits.

### Examples 32

### Potato chips

Peeled potatoes sliced into small pieces each having a thickness of 1 mm were dipped for 5 minutes in an aqueous solution of 1% salt containing each of various compounds to be tested, followed by removing the aqueous solution from the sliced potatoes, and subsequently frying the sliced potatoes at 175° C. for 90 seconds with a vegetable oil so as to obtain potato chips.

Table 6 shows the amount of acrylamide (AA) contained in the obtained potato chips in a relative value based on a control. In the control, the acrylamide content was measured under the same conditions as those described above, except that the test compound was not used therein.

TABLE 6
AA amount in French frier (ratio to control)

| | Concentration of solution | | | |
|---|---|---|---|---|
| Tested compound | 2.00% | 1.00% | 0.50% | 0.25% |
| Glycine | 0.40 | 0.83 | 0.92 | — |
| L-Cysteine hydrochloride | — | 0.15 | — | — |
| L-Lysine hydrochloride | 0.67 | 0.78 | 0.88 | 1.05 |
| L-Histidine | — | 0.79 | — | — |
| Taurine | — | 0.53 | 0.85 | — |
| L-ArginineL-glutamate | — | 0.61 | — | — |
| L-LysineL-glutamate | — | 0.61 | — | — |
| Polylysine | — | 0.75 | — | — |

As apparent from the results shown in Table 6, the amount of acrylamide contained in the potato chips can be effectively lowered in the case where the sliced potato pieces are dipped in an aqueous solution containing at least 0.5% of any of glycine, L-lysine hydrochloride and taurine or in an aqueous solution containing at least 1.0% of any of L-cysteine hydrochloride, L-histidine, L-arginineL-glutamate, L-lysineL-glutamate and polylysine. In other words, the use of these compounds provides a method of preparing potato chips with decreased acrylamide.

### Example 33

### Biscuits

For preparing biscuit dough, 15 g of sugar and 5 g of isomerized sugar were mixed with 12.5 g of shortening, followed by adding to the mixture 15 g of an aqueous solution containing 0.25 g of each of the compounds to be tested. Then, a mixture consisting of 50 g of sieved flour and 0.5 g of sodium hydrogencarbonate was added to the mixture, followed by stretched the kneaded mixture so as to obtain biscuit dough having a thickness of 5 mm. The biscuit dough thus prepared was cooled in a refrigerator and, then, cut out with a circular molding die with a diameter of 4 cm. These circular pieces were baked at 170° C. for 22 minutes in an oven so as to obtain biscuits. Table 7 shows the amount of acrylamide (AA) contained in the biscuits thus obtained. In a control shown in Table 7, the acrylamide content was measured under the same conditions as those described above, except that the test compound was not used therein.

TABLE 7

| Tested compound | Analyzed AA value (ppb) |
|---|---|
| Control | 60 |
| L-Proline | 39 |
| L-Cysteine | 41 |
| hydrochloride | |
| Glycine | 44 |
| Taurine | 44 |
| L-Lysine | 52 |
| hydrochloride | |
| L-Histidine | 52 |

As apparent from the results shown in Table 7, the amount of acrylamide contained in biscuits is efficiently decreased by the addition of any of L-proline, L-cysteine hydrochloride, glycine, taurine, L-lysine hydrochloride and L-histidine in an amount of 0.5% to the amount of flour. In other words, the use of these compounds provides a method of preparing biscuits with decreased acrylamide.

Comparative Example 6 and Examples 34 to 46 given below are a Comparative Example and Examples of the present invention in which the methods of the present invention are applied to French frier. The results are shown herein later in Table 8.

A hundred g of potatoes for French frier on sale as frozen foods (¼ inch-cut, shoestrings cut) were dipped for 5 minutes in an aqueous solution containing 1% of each of various compounds to be tested, followed by removing the aqueous solution from the potatoes for 2 minutes and subsequently frying the potatoes at 180° C. for 3 minutes with a vegetable oil (corn vegetable oil) so as to obtain French frier. Comparative Example 6 was conducted in the same manner as above, except that each of the various test compounds were not used therein.

The blending conditions of the dipping solution and the acrylamide content of the French frier prepared in Comparative Example 6 and Examples 34 to 46 are shown in Table 8.

TABLE 8

| | Comp. | Exam- | Exam- | Exam- | Exam- | | | |
|---|---|---|---|---|---|---|---|---|
| | 6 | ple 34 | ple 35 | ple 36 | ple 37 | Example 38 | Example 39 | Example 40 |
| Blending condition of dipping | | | | | | | | |
| solution | | | | | | | | |
| Water | 500 g | 495 g | 495 g | 495 g | 495 g | 495 g | 495 g | 495 g |
| Glycine | — | 5 g | — | — | — | — | — | — |
| L-Alanine | — | — | 5 g | — | — | — | — | — |
| L-Serine | — | — | — | 5 g | — | — | — | — |
| L-Cysteine hydrochloride | — | — | — | — | 5 g | — | — | — |
| L-Lysine hydrochloride | — | — | — | — | — | 5 g | — | — |
| L-arginine | — | — | — | — | — | — | 5 g | — |
| L-histidine | — | — | — | — | — | — | — | 5 g |
| Analyzed AA value (ppb) | 468 | 240 | 346 | 391 | 49 | 216 | 436 | 261 |

| | Example 41 | Example 42 | Example 43 | Example 44 | Example 45 | Example 46 |
|---|---|---|---|---|---|---|
| Blending condition of dipping | | | | | | |
| solution | | | | | | |
| Water | 495 g | 495 g | 495 g | 495 g | 495 g | 495 g |
| L-Proline | 5 g | — | — | — | — | — |
| L-Hydroxyproline | — | 5 g | — | — | — | — |
| Taurine | — | — | 5 g | — | — | — |
| L-ArginineL-glutamate | — | — | — | 5 g | — | — |
| L-LysineL-glutamate | — | — | — | — | 5 g | — |
| Polylysine | — | — | — | — | — | 5 g |
| Analyzed AA value (ppb) | 312 | 297 | 182 | 319 | 258 | 338 |

As apparent from the results in Table 8, the addition of amino acids or sulfonic acid to French frier allowed effective decrease in acrylamide contained therein. Glycine, L-cysteine hydrochloride, L-lysine hydrochloride, L-histidine, taurine and L-lysineL-glutamate were particularly effective for decreasing acrylamide. In other words, the use of these compounds provides a method of preparing French frier with decreased acrylamide.

### Measuring Example 1

### Model Test for Suppressing Acrylamide Formation

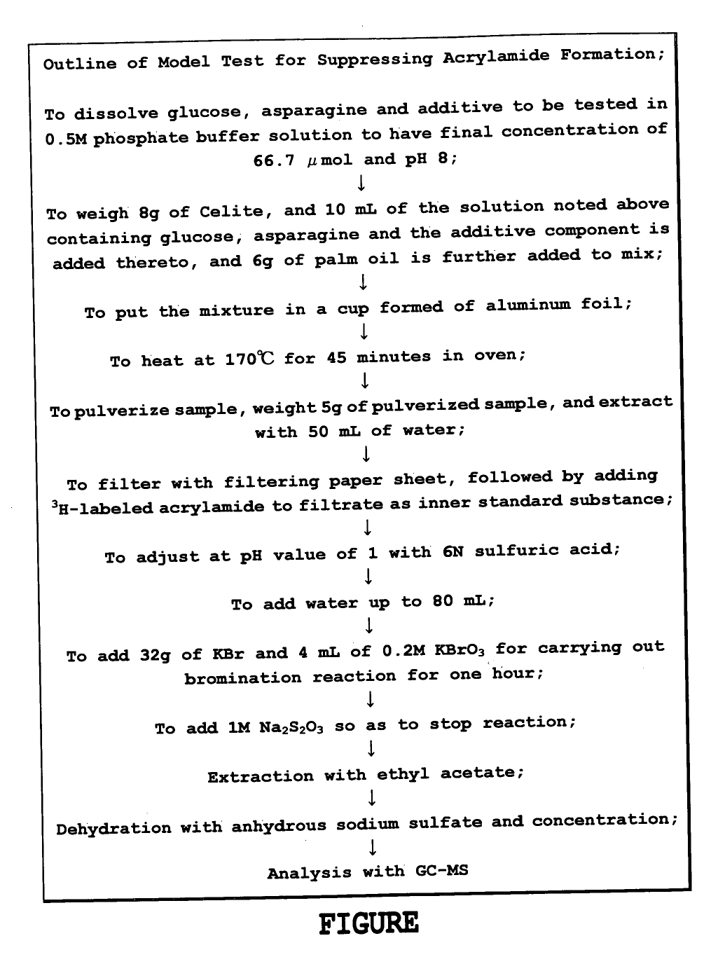

The functions of various compounds for suppressing the acrylamide formation were measured by the method outlined in FIG. 1. The method shown in FIG. 1, which has been devised by the present inventors based on the technical ideas disclosed in “Chemical Research in Toxicology 13”, pp. 517-522 (2000) and “Nature” 419, pp. 448-450 (2002) referred to previously in conjunction with the prior art, can be significantly used as a model test for estimating the function of suppressing the acrylamide formation which is attained by the compound to be tested in the food cooked under heat.

Table 9 shows the ratio by weight of the amount of generation of acrylamide for each test additive relative to a control.

TABLE 9

| | Generated |
|---|---|
| | acrylamide amount |
| Tested compound | (ratio to control) |
| L-Lysine hydrochloride | 0.35 |
| L-Cysteine hydrochloride | 0.35 |
| L-LysineL-glutamate | 0.39 |
| Taurine | 0.43 |
| Glutathione (oxidized form) | 0.47 |
| β-Alanine | 0.50 |
| L-ArginineL-glutamate | 0.52 |
| Glutathione (reduced form) | 0.57 |
| L-Lysine | 0.58 |
| L-Cysteine | 0.58 |
| Glycine | 0.59 |
| L-Histidine | 0.59 |
| L-Serine | 0.60 |
| DL-Alanine | 0.61 |
| L-Histidine hydrochloride | 0.62 |
| L-Arginine | 0.64 |
| L-Proline | 0.65 |
| L-Hydroxyproline | 0.70 |
| L-Glutamic acid (Comparison) | 0.71 |

The compounds that are effective for suppressing the acrylamide formation in the model test can be found from Table 9. Particularly, the compounds such as L-lysine hydrochloride, L-cysteine hydrochloride, taurine, β-alanine, L-lysine, L-cysteine, glycine, L-histidine and L-serine, which are the compounds belonging to the neutral amino acid, the basic amino acid and sulfonic acid, allow to suppress the acrylamide formation very effectively. As also apparent from the results shown in Table 9, the compounds mentioned above allow to suppress the acrylamide formation effectively, when compared with L-glutamic acid used as a comparison.

### Measuring Example 2

### Model Test for Suppressing Acrylamide Formation Using Wheat Flour)

Ten mL of 0.51% “kansui” solution into which 10 g of wheat flour and 50 mg of each additive, were mixed with 3 g of palm oil. The mixture was put into a cup made of aluminum foil, and heated in an oven at 180° C. for 45 minutes. After that, the amount of acrylamide was measured in accordance with the manner described in FIG. 1, thereby to estimate the suppressing ability against acrylamide formation.

TABLE 10

| | Generated |
|---|---|
| | acrylamide amount |
| Tested compound | (ratio to control) |
| β-Alanine | 0.34 |
| γ-Aminobutyric acid | 0.33 |
| Ornithine hydrochloride | 0.36 |

As apparent from Table 10, in the model test using wheat flour, β-alanine, γ-aminobutylic acid and ornithine hydrochloride functioned in a suppressive manner against acrylamide formation. β-alanine and γ-aminobutylic acid belong to the neutral amino acid, and ornithine belongs to the basic amino acid. It is apparent that these amino acids effectively suppress the formation of acrylamide.

### Measuring Example 3

### Method of Measuring Acrylamide Content In Fried Noodles

(i) Extraction From Noodles

Ten g of pulverized noodle sample immediately after the frying was weighed, and a prescribed amount of a heavy hydrogen labeled acrylamide was added to the sample as an internal standard substance. As the standard addition segment, acrylamide and heavy hydrogen labeled acrylamide were added to the same amount of the noodle sample. Distilled water in an amount of 100 mL (milliliters) was added to each of these samples and, after homogenization and extraction by shaking for 5 minutes, the supernatant separated by the centrifugal operation was recovered. Then, a distilled water in an amount of 60 mL was added to the residue of the sample, followed by extraction by shaking and separation by centrifugation two times so as to obtain the separated supernatant liquid. Further, the supernatant liquid thus obtained was subjected to the suction filtration so as to obtain about 200 mL of the extracted liquid.

(ii) Bromination of Extracted Acrylamide

About 250 mL of the extracted liquid having the pH value adjusted with sulfuric acid was quantitatively separated in accordance with the measuring method of acrylamide monomer specified in “Guide Line of Test Method for Evaluating the City Water Chemicals” published in March, 2000 by the Waterworks Maintenance Section, Waterworks Environment Department of the Livelihood Bureau, the former Ministry of Health and Welfare. Then, 100 g of potassium boride was dissolved in the extracted liquid thus separated.

Further, 12.5 mL of 0.2M potassium bromate solution was added for carrying out the reaction for 60 minutes so as to achieve the bromination.

(iii) Debromination From Reaction Mixture

The free bromine was removed by adding 1M sodium thiosulfate drop-wise immediately after 60 minutes.

(iv) Extraction of Brominated Acrylamide

The total amount of the bromination reaction mixture and 25 mL of ethyl acetate were put in a separatory funnel, and the funnel was allowed to stand still after vibration for 5 minutes so as to recover the ethyl acetate layer. Then, 10 mL of ethyl acetate was added to the residual water layer, followed by recovering the ethyl acetate layer. The operations described above were carried out twice so as to obtain about 45 mL of the solvent extracted liquid in a centrifugal tube.

(v) Dehydration of Extracted Solvent

The solvent extracted liquid was centrifuged so as to remove the water layer, and 10 g of anhydrous sodium sulfate was added to the ethyl acetate layer. After the residue was allowed to stand still for 30 minutes, the residue was dehydrated and, then, filtered.

(vi) Condensation of Solvent Extracted Liquid

The solvent extracted liquid was condensed to about 5 mL by using a rotary evaporator, followed by adding ethyl acetate up to a constant volume of 10 mL, thereby obtaining a solution for examination.

(vii) Measurement of Acrylamide by GC-MS

A part of the solution for examination thus obtained was taken out, and triethylamine was added to the solution for examination. After the mixed solution was left to stand for 20 minutes, the GC-MS analysis was applied. The acrylamide content was calculated from the area ratio of the heavy hydrogen labeled acrylamide added as an internal standard substance to acrylamide.

The acrylamide contents of foods other than noodles were measured in the similar manner by appropriately changing the above method.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method of preparing food to be cooked under heat or food cooked under heat, which is capable of decreasing acrylamide contained in the food after the cooking, wherein the method comprises adding to the food at least one compound selected from the group consisting of (a1) neutral amino acids and salts thereof, (a2) basic amino acids and salts thereof, (a3) neutral imino acids and salts thereof, (b) sulfonic acids and salts thereof and/or at least one peptide complex of peptides having, as constituting components thereof, any one of the amino acids of the items (a1) to (a3).

2. The method of preparing food to be cooked under heat or food cooked under heat according to claim 1, wherein
the neutral amino acid and the salt thereof belonging to item (a1) are selected from nonpolar neutral amino acids consisting of glycine, alanine and salts thereof, and polar neutral amino acids consisting of serine, cysteine and salts thereof;
the basic amino acid and the salt thereof belonging to item (a2) are selected from the group consisting of lysine, arginine, histidine and salts thereof;
the neutral imino acid and the salt thereof belonging to item (a3) are selected from the group consisting of proline, hydroxyproline and salts thereof; and
the sulfonic acid and salt thereof belonging to item (b) is taurine.

3. The method of preparing food to be cooked under heat or food cooked under heat according to claim 1, wherein
the salt includes an amino acid salt selected from the group consisting of L-arginineL-glutamate and L-lysineL-glutamate; and
the peptide complex is selected from the group consisting of glutathione and polylysine.

4. The method of preparing food to be cooked under heat or food cooked under heat according to claim 1, wherein the food contains a cereal flour and/or starch.

5. The method of preparing food to be cooked under heat or food cooked under heat according to claim 1, wherein the temperature at which the food is to be cooked or cooked under heat is not lower than 120° C.

6. The method of preparing food to be cooked under heat or food cooked under heat according to claim 5, wherein the cooking under heat is carried out by frying, stir-frying or roasting.

7. The method of preparing food to be cooked under heat or food cooked under heat according to claim 1, wherein the food is selected from the group consisting of noodles, tempura (Japanese deep-fried food), baked confectionery, fried confectionery, snacks and foods having wrapping sheet of dough made of a cereal flour or starch.

8. The method of preparing food to be cooked under heat or food cooked under heat according to claim 7, wherein the baked confectionery is biscuits, the fried confectionery is Karintou, the snacks is potato chips, and the foods having wrapping sheet of dough are selected from Agegyouza and Yakigyouza.

9. The method of preparing food to be cooked under heat or food cooked under heat according to claim 1, wherein the food is to be cooked or cooked at a temperature for a period of time which permit the amount of acrylamide to be increased after the cooking under heat, compared with the amount of acrylamide contained in the food before the cooking under heat, in the case where the food to which the compound and/or the peptide complex is not added, is cooked under heat.

10. The method of preparing food to be cooked under heat according to claim 1, wherein the method does not comprise final cooking of the food under heat to which the compound and/or the peptide complex is added thereby to prepare the food to be cooked under heat.

11. The method of preparing food cooked under heat according to claim 1, wherein the method further comprises cooking the food to which the compound and/or the peptide complex is added, by cooking under heat thereby to prepare the food cooked under heat.

12. Food before cooking under heat, which is prepared by the method according to claim 1, and which is capable of lowering acrylamide contained in the food after the cooking under heat.

13. Food cooked under heat, which is prepared by the method according to claim 1, and in which acrylamide was lowered.
